(19) United States
(12) Patent Application Publication
(10) Pub. No.: US 2014/0244531 A1
(43) Pub. Date: Aug. 28, 2014

(54) TECHNIQUES FOR USING SOCIAL PROXIMITY SCORES IN RECRUITING AND/OR HIRING

(71) Applicant: LinkedIn Corporation, Mountain View, CA (US)

(72) Inventors: Tyler Baldwin, Santa Clara, CA (US); Chen Chang, San Jose, CA (US); Joshua Richard VanGeest, Sunnyvale, CA (US); Mike Derezin, Alamo, CA (US)

(73) Assignee: LinkedIn Corporation, Mountain View, CA (US)

(21) Appl. No.: 14/015,751

(22) Filed: Aug. 30, 2013

Related U.S. Application Data
(63) Continuation-in-part of application No. 13/781,408, filed on Feb. 28, 2013.
Application No. 13/781,408 is a continuation-in-part of application No. 13/781,569, filed on Feb. 28, 2013.

(51) Int. Cl. G06Q 10/10; G06Q 50/00

(52) U.S. Cl. CPC G06Q 10/1053; G06Q 50/01
USPC 705/319

(57) ABSTRACT

Techniques for analyzing a social graph of a social networking service to derive a social proximity score representing a measure of how socially connected a member is to a target entity are described. With some embodiments, an aggregate social proximity score is derived to reflect a measure of how well socially connected a person is to a set of organizations representing customer accounts of a business organization. Accordingly, the aggregate social proximity score can be used to compare candidates in a hiring decision, or to identify potential candidates during recruiting.

### CROSS REFERENCE TO RELATED APPLICATIONS

This application is a continuation-in-part application of, and claims priority under 35 U.S.C. §120 to, both U.S. patent application Ser. No. 13/781,408, filed on Feb. 28, 2013, entitled “TECHNIQUES FOR DERIVING A SOCIAL PROXIMITY SCORE FOR USE IN ALLOCATING RESOURCES,” and U.S. patent application Ser. No. 13/781,569, filed on Feb. 28, 2013, entitled “TECHNIQUES FOR ALLOCATING RESOURCES BASED ON A SOCIAL PROXIMITY SCORE,” which are hereby incorporated by reference in their entirety.

### TECHNICAL FIELD

The present disclosure generally relates to data processing systems. More specifically, the present disclosure relates to methods, systems and computer program products for use in deriving and then utilizing social proximity scores, representing a measure of how socially connected a person is to an entity (e.g., a company or other organization), as an aid in the decision making processes associated with the recruiting and/or hiring of employees generally, and sales representatives in particular.

### BACKGROUND

The success of any business organization depends largely on the effectiveness of the organization's sales team. A business organization with excellent manufacturing operations, cutting-edge technology, tight financial goals, and progressive management techniques will still struggle if it lacks an effective sales mechanism. At least one aspect that impacts the overall effectiveness of a sales team is the manner in which sales resources—that is, the individual members of the sales team (commonly referred to as sales representatives)—are allocated or assigned to the various customer accounts of the business organization. Conventional thinking regarding the allocation of sales resources typically focusses on one or more market segmentation techniques. For example, as illustrated in FIG. 1, many business organizations segment a target market into different geographical regions or territories, and then allocate sales representatives to manage customer accounts based on the geographical region of the customer and the sales representatives. While such a technique may prove more effective than randomly allocating customer accounts to sales representatives, more effective techniques for allocating sales resources are described in U.S. patent application Ser. No. 13/781,408, entitled “TECHNIQUES FOR DERIVING A SOCIAL PROXIMITY SCORE FOR USE IN ALLOCATING RESOURCES,” (hereinafter, “the '408 application”), and U.S. patent application Ser. No. 13/781,569, entitled “TECHNIQUES FOR ALLOCATING RESOURCES BASED ON A SOCIAL PROXIMITY SCORE,” (hereinafter, “the '569 application”). However, while the techniques described in the '408 application and the '569 application ensure that existing sales resources (e.g., sales representatives) are efficiently and intelligently allocated to existing and/or potential customer accounts, the techniques described do not address the difficulties faced in recruiting and hiring top sales representatives.

### DESCRIPTION OF THE DRAWINGS

Some embodiments are illustrated by way of example and not limitation in the FIG.s of the accompanying drawings, in which:

FIG. 1 is a diagram illustrating a conventional technique for allocating resources based on a geographical segmentation of a market;

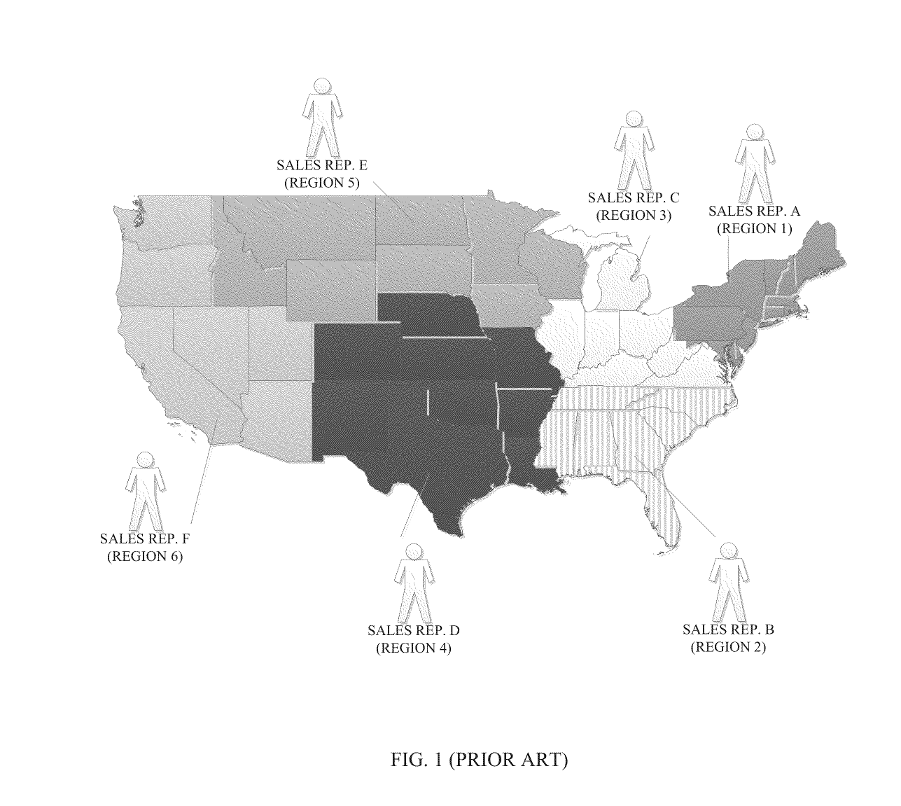

FIG. 2 is a block diagram showing the functional components of a social networking service, including a data processing module referred to herein as a social proximity score-generating module for use in deriving a social proximity score representing a measure of how socially connected a member is to an entity (e.g., a company), consistent with some embodiments of the invention;

FIG. 3 is a block diagram illustrating an example of a portion of a graph data structure for modelling a social graph, according to some embodiments of the invention;

FIG. 4 is a flow diagram illustrating the method operations involved in a method for computing or deriving a social proximity score, consistent with some embodiments of the invention;

FIG. 5 is a diagram showing an abstract representation of a target entity (e.g., a company) with employees being members of a social networking service and being segmented by certain predefined criteria (e.g., job titles, job functions, seniority), consistent with some embodiments of the invention;

FIG. 6 is a table illustrating an example of the output data provided by a social proximity score-generating module, consistent with some embodiments of the invention;

FIG. 7 is a block diagram illustrating an example of the inputs and outputs of a resource allocation module, consistent with some embodiments of the invention;

FIG. 8 is a user interface diagram illustrating an example of the output of a resource allocation module, consistent with some embodiments of the invention;

FIG. 9 is a block diagram of a machine in the form of a computing device within which a set of instructions, for causing the machine to perform any one or more of the methodologies discussed herein, may be executed;

FIG. 10 is a diagram illustrating an example of a market segmented into various regions or territories, with one such region having been vacated by its assigned sales representative;

FIG. 11 is a diagram illustrating how an aggregate social proximity score is assigned to each of three candidates vying for an open sales representative position, consistent with some embodiments of the invention;

FIG. 12 is a flow diagram illustrating the operations of a method for deriving and presenting an aggregate social proximity score for a candidate being considered for an open sales representative position that is associated with a set of customer accounts, according to some embodiments;

FIG. 13 is a block diagram showing the functional components of a social networking service, including a data processing module referred to herein as a social proximity score-generating module for use in deriving an aggregate social proximity score representing a measure of how socially connected a member is to a set of entities (e.g., companies) representing customer accounts of a business organization, consistent with some embodiments of the invention; and

FIG. 14 is a flow diagram illustrating the operations of a method for receiving and processing a search query, where at least one component of the search query is a minimum aggregate social proximity score for a set of customer accounts; and

FIG. 15 is a user interface diagram showing a set of search results, where each search result includes a social proximity score, consistent with some embodiments.

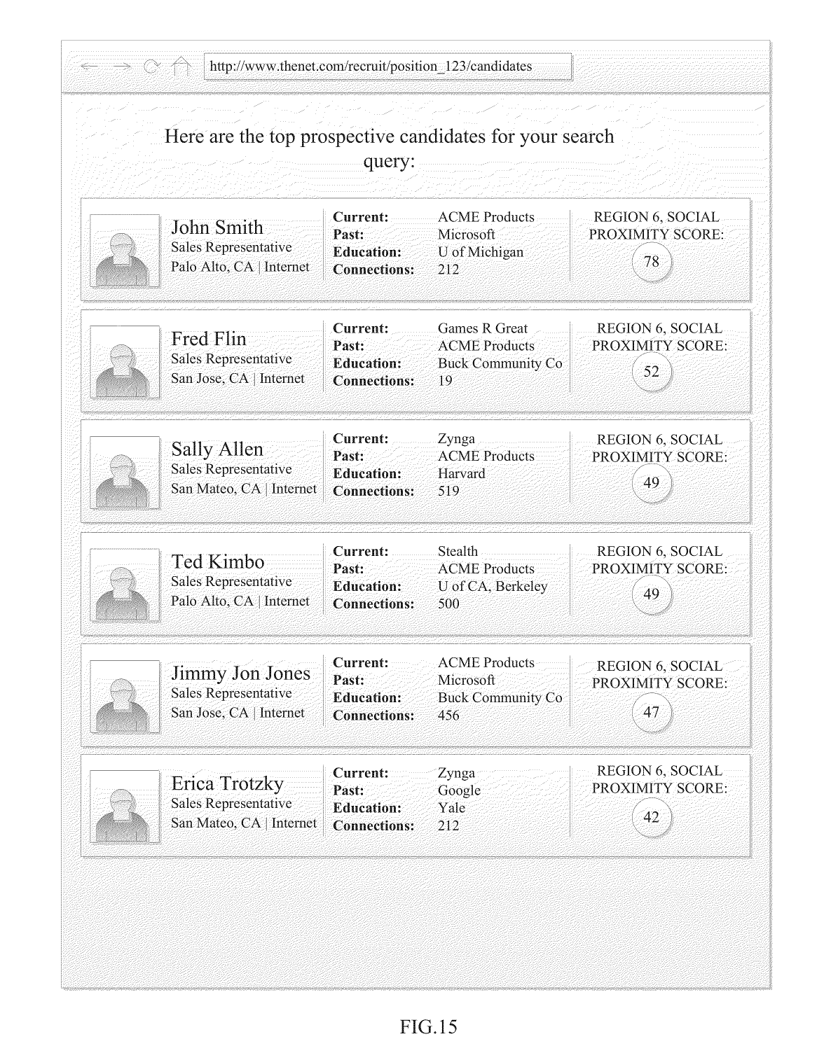

### DETAILED DESCRIPTION

The present disclosure describes methods, systems and computer program products for use in facilitating the recruiting and/or hiring of sales representative candidates, based at least in part on deriving and presenting an overall score for each candidate that reflects the extent to which the respective candidate is socially connected to a set of existing and/or potential customer accounts of the hiring organization. With some embodiments, an overall score (e.g., an aggregate social proximity score) may be assigned to each of two or more sales representative candidates vying for a single open sales representative position, such that a comparison of the overall scores of the two or more respective candidates may be used as an aid in the actual hiring decision. For instance, a candidate with a higher score may be preferred over others as a higher score generally indicates that the candidate may be more socially connected to the individual organizations representing the customer accounts in the predefined set of customer accounts that the candidate is being hired to call on and service. Accordingly, with some embodiments, by deriving and presenting an overall social proximity score for two or more candidates, the overall social proximity scores can be used as an aid in the decision making process for candidate hiring.

Alternatively, with some embodiments a recruiter may specify a minimum aggregate social proximity score as one component of a search query, such that the search query may be used to identify potential candidates for an open sales representative position who have an aggregate social proximity score that meets or exceeds the recruiter-specified minimum score. Accordingly, with some embodiments, an aggregate or overall social proximity score may be used as an aid in the recruiting process.

Consistent with some embodiments, an overall score is generally derived as a combination or aggregate of individual social proximity scores. In the context of the present disclosure, a social proximity score is a score (e.g., a number) that represents a measure of how socially connected an individual is to another entity represented in a social graph maintained by a social networking service, such as a company, educational institution, government entity or organization, non-profit organization, or any other type of organization. A social proximity score may be derived in accordance with any of the techniques described herein. By deriving for a particular candidate a social proximity score for each of several existing or potential customer accounts in a predefined set of customer accounts, the extent to which a particular candidate is socially connected to any one entity representing a customer account may be measured and presented. Similarly, by combining the individual social proximity scores for each customer account in the predefined set of customer accounts, an aggregate or overall social proximity score can be used to measure how socially connected a particular sales representative candidate is to a predefined set of customer accounts, for example, such as those customer accounts that are within or assigned to some predefined territory, or a specific set of customer accounts that were previously being managed by a sales representative who has recently departed an organization.

While the many examples presented herein describe the use of social proximity scores in techniques for allocating accounts to sales representatives, and the hiring and recruiting of sales representatives, skilled artisans will readily recognize that the inventive subject matter described herein can quite easily be adapted for other uses. In particular, by tailoring the algorithm(s) used in deriving a social proximity score, the techniques described herein can easily be adapted for other uses, for example, such as allocating customer accounts to employees in general (e.g., employees other than sales representatives) and the hiring and recruiting of other types of employees. Generally, the techniques described herein can be adapted to facilitate and aid in any decision making process where a decision depends in part on how socially connected a person is to another entity or organization. Other aspects and advantages of the inventive subject matter are described in the description of the figures that follows.

### Deriving Social Proximity Scores and Allocating Resources

As described in greater detail below, with some embodiments, for each member of a social networking service in a particular group of members (e.g., each sales representative for a particular business organization) and a particular target entity (e.g., a customer account of the business organization), a social proximity score is derived based on analysis of the social graph maintained by the social networking service, and in some instances, analysis of the individual member profiles of members who are connected via the social graph. In addition, with some embodiments, the interactions that individual members of the social networking service have with one another may be tracked and used in deriving social proximity scores.

In various embodiments a social proximity score may be derived based on various factors, including but not limited to any one or more of the following: the number of connections that a member has with other members employed with the target entity, the number of connections of a particular type or degree (e.g., first-degree connections, second-degree connections, etc.) that the member has with other members employed with the target entity, the number of connections that the member has with other members employed with the target entity who satisfy certain criteria (e.g., key decision makers, as indicated by member profile attributes, social graph information, or activity/behavioral data). With some embodiments, a social proximity score may be based on some weighted combination of the above factors. For example, in deriving a social proximity score, the number of first-degree connections may be weighted with a weighting factor to contribute more to the overall social proximity score than second-degree connections. Similarly, connections to members employed with the target entity and satisfying certain criteria (e.g., job function, job title, seniority level, etc.) may be weighted more heavily than connections to members employed with the target entity, but not satisfying the criteria.

With some embodiments, a social proximity score reflects not only the number of connections, or the number of connections of a particular type, or which satisfy some criteria, but also the strength of individual connections. For example, as described in greater detail below, in some instances the social graph maintained by the social networking service will reflect the strength of a connection path connecting any two nodes (e.g., members) in the social graph. With some embodiments, the connection strength of a connection path connecting two members may be used as a weighting factor when deriving the social proximity score for a particular member and target entity pair. In general, the connection strength of a connection path connecting two members may be based on a variety of factors including factors derived from analysis of various member profile attributes, social graph information, as well as activity or behavioral data.

Consistent with some embodiments of the present invention, a software application or service includes functionality that facilitates and supports the resource allocation decision-making process—that is, the process by which resources and particularly human resources (e.g., sales representatives, recruiters, marketing specialists) are allocated or assigned to existing customer accounts, new customer accounts, customer leads, and so forth. Accordingly, the software application or service includes a score-generating module that receives as input some information identifying a member of a social networking service and some information identifying a target entity (e.g., a company). Using these two inputs, the score-generating module analyzes a variety of social graph and member profile information, and computes or derives a social proximity score representing a measure of how socially connected the member is to the particular target entity. With some embodiments, this process is repeated for any number of members of a defined group, for example, such as a set of sales representatives on a sales team. The process may also be repeated for any number of target entities. Once the social proximity scores are determined for each member of the team, and for any number of target entities, the scores may be used as one of any number of inputs to a process or tool that facilitates and/or supports the resource allocation decision-making process. For example, for a particular target entity, a group of sales representatives may be displayed in order of their corresponding social proximity scores, such that the sales representative who has the highest social proximity score and is the most socially connected to the target entity, appears at or near the top of a list. Additional user interface elements may allow for an administrator to quickly and easily make resource allocation decisions, for example, by simply selecting or interacting with user interface elements (e.g., buttons, drop-down lists, links, etc.) to memorialize resource allocation decisions.

As described in greater detail below, with some embodiments, the social proximity score for a particular member and target entity pairing is derived as a function of the number of connections that the particular member has to other members of the social networking service who, based on their respective member profile information, have indicated they are employed with the target entity. Accordingly, with some embodiments, one of the operations performed is a query to identify the set of all members of the social networking service who, according to the social graph or information in their respective member profiles, are currently employed with the target entity. Next, analysis of the social graph is performed to identify all of the connections that the particular member has with other members in the set of members of the social networking service who are currently employed with the target entity. In various alternative embodiments, only connections of a certain degree are considered and will contribute to the social proximity score. For example, in some instances, only first-degree or direct connections will contribute to the social proximity score. Similarly, in some instances, first and second-degree connections will contribute to the social proximity score, where a second-degree connection is a connection that involves one intermediate node (e.g., a friend-of-a-friend). In those instances in which both first and second-degree connections contribute to the overall social proximity score, one or more weighting factors may be used to increase the contribution of first-degree connections to the overall social proximity score, relative to the contribution of second-degree connections. This may be done to reflect the fact that first-degree or direct connections typically are more highly valued because they reflect a greater level of social connectedness than second-degree connections.

Just as first-degree and second-degree connections may not contribute equally to the social proximity score, with some embodiments not all connections of the same degree (e.g., all first-degree connections) contribute equally to the social proximity score. For example, if the particular member for whom the social proximity score is being derived is connected to a member of the social networking service who is employed at the target entity in a decision-making capacity, the connection may be of greater importance than a first-degree connection to another member employed in a different and less important capacity. Accordingly, with some embodiments, various weighting factors are applied to connections between the member and other members who have member profile information satisfying some predetermined criteria, or where the social graph information satisfies some predetermined criteria.

For instance, consider a scenario in which a sales representative of a computer supply company is being allocated or assigned to a new customer account (e.g., the target entity). If the sales representative is connected via the social graph of the social networking service to one or more members of the social networking service who have member profile information indicating employment with the target entity in a particular role (e.g., Director of Information Technology, Information Technology Manager, Purchasing Manager, etc.), a weighting factor may be applied to that connection or those connections to reflect their relatively greater value in terms of their significance in representing social connectedness than first-degree connections to other members employed with the target entity in positions not relevant to making information technology purchasing decisions. With some embodiments, the weighting factors that are applied to certain connections between the particular member and the employee-member of the target entity are dependent upon members having specified particular job titles, and/or job functions in their respective member profiles. Additionally, or alternatively, member profile information indicating a member's seniority level may be taken into consideration, such that connections with members who satisfy some seniority requirement are weighted to reflect a greater significance in representing social connectedness. Of course, with some embodiments, member profile characteristics other than job title, job function and seniority level may be considered and associated with different weighting factors. In some instances, a connection to a particular person (e.g., the Chief Executive Officer, the Director of Sales, the General Counsel) may be deemed important, such that the criteria may not be a job title, but the actual name of the person. With some embodiments, different weighting factors may be associated with different sets of criteria, such that a connection with a member of the social networking service who has member profile information satisfying a first set of criteria will have a first weighting factor applied, and a connection with a member having member profile information satisfying a second set of criteria will have a second weighting factor applied. As such, certain categories of connections meeting different criteria may be afforded a different weighting factor to reflect their relative importance in computing the social proximity score for a particular member and target entity pairing.

Because certain connections to members employed at the target entity (e.g., company) may be deemed more important or valuable than others, when certain criteria are met some connections may have a weighting factor applied to increase their overall influence or impact on the social proximity score. For example, if a particular member (e.g., a sales representative) is connected to a member of the social networking service who is employed at the target entity, and the two members share a certain threshold number of connections in common, a weighting factor may be applied. Similarly, if the two members previously worked at the same company, either at different times or at the same time, a weighting factor may be applied to the connection to increase its contribution to the overall social proximity score. Weighting factors may also be applied when the two connected members share in common certain member profile attributes (e.g., job title, geographic location of employment or residence, etc.), share in common a certain number or set of skills, and/or graduated or attended the same school.

With some embodiments, one or more operations may be performed to normalize the social proximity scores, for example, to account for variations in the size (e.g., number of employees) of different companies. This makes comparison of social proximity scores for different target entities (e.g. companies) more meaningful. For example, a very large company may have hundreds of senior level people with a common job title (e.g., Vice President of Sales), whereas a small company may have only one employee with such a title. If a business organization has a sales representative that is connected via the social networking service to the one and only employee of the small company with the title, Vice President of Sales, this is a much more meaningful data signal than having a sales representative with a connection to one employee of the hundreds of employees of a large company with the same title, Vice President of Sales. Accordingly, with some embodiments, when deriving the social proximity score, the number of connections to members having member profile information satisfying some criteria may be divided by the total number of members employed at the target entity who have member profile information satisfying that criteria. As such, a connection to the one and only employee of a target company having member profile information satisfying some predefined criteria (e.g., job title=“V.P. of Sales”) will contribute more toward a social proximity score than will a single connection to a member satisfying the same criteria, when there are multiple employees having member profile information satisfying that criteria.

With some embodiments, the total number of connections (particularly second-degree connections) that a member may have with other members employed at a target entity may be extremely high. Accordingly, with some embodiments, a logarithmic scale is used to deemphasize the relative impact that each additional connection may have to the social proximity score, particularly when there are a large number of connections. When the number of connections is being normalized to account for the total possible number of connections, the logarithm operation is applied to both the numerator (representing the number of connections of a particular type that a member has with a target entity) and the denominator (representing the total number of possible connections of that particular type).

With some embodiments, an administrative user interface enables an administrator with appropriate privileges to configure various parameters and settings that affect the algorithm or process by which a social proximity score is computed or derived. In particular, an administrator-specified parameter or setting may define the particular type or degree of connections (e.g., first degree, second degree, third degree, and so forth) that are considered in deriving the social proximity score. In addition, an administrator may specify various parameters or settings for the weighting factors that are applied to different connection degrees (e.g., first-degree connections vs. second-degree connections) as well as connections with members having member profile information satisfying certain administrator-specified criteria (e.g., certain job titles, job functions, seniority levels, etc.). Additionally, with some embodiments, the administrative interface enables an administrator to specify various criteria (e.g., member profile attributes, social graph information, or activity/behavioural data) and corresponding weighting factors, such that, when deriving a social proximity score, a connection with a member having member profile information satisfying the administrator-specified criteria will be weighted in accordance with the corresponding administrator-specified weighting factor. In this way, the administrator can specify the member profile characteristics (e.g., job titles, job functions, seniority levels, and so forth) that are deemed important in the particular context for which the social proximity scores are being derived. With some embodiments, in addition to specifying criteria involving certain member profile attributes, an administrator may specify that weighting factors are to be applied to connections where certain criteria relating to the social graph are satisfied—for example, where the two connected members share a certain threshold number of mutual connections. Similarly, weighting factors may be applied to those connections for which two members are actively engaged with one another, as evidenced by activity or behavioral data.

By providing the flexibility to dynamically configure the manner in which the social proximity scores are derived, the social proximity scores can be used to support a variety of different decision making processes. For example, if the social proximity scores are being generated with a view to allocating sales representatives to customer accounts, an administrator can specify that connections to employees of the target entity employed in senior sales-related decision making positions are to be weighted more heavily than connections with other members who are less senior and/or employed in non-sales-related roles. Specifically, by mapping different weighting factors to different sets of criteria (e.g., different job titles, job functions and seniority levels), an administrator can tailor the algorithm for computing social proximity scores to suit a particular decision making process. Other advantages and aspects of the several embodiments of the present invention will be readily apparent from the description of the figures that follows.

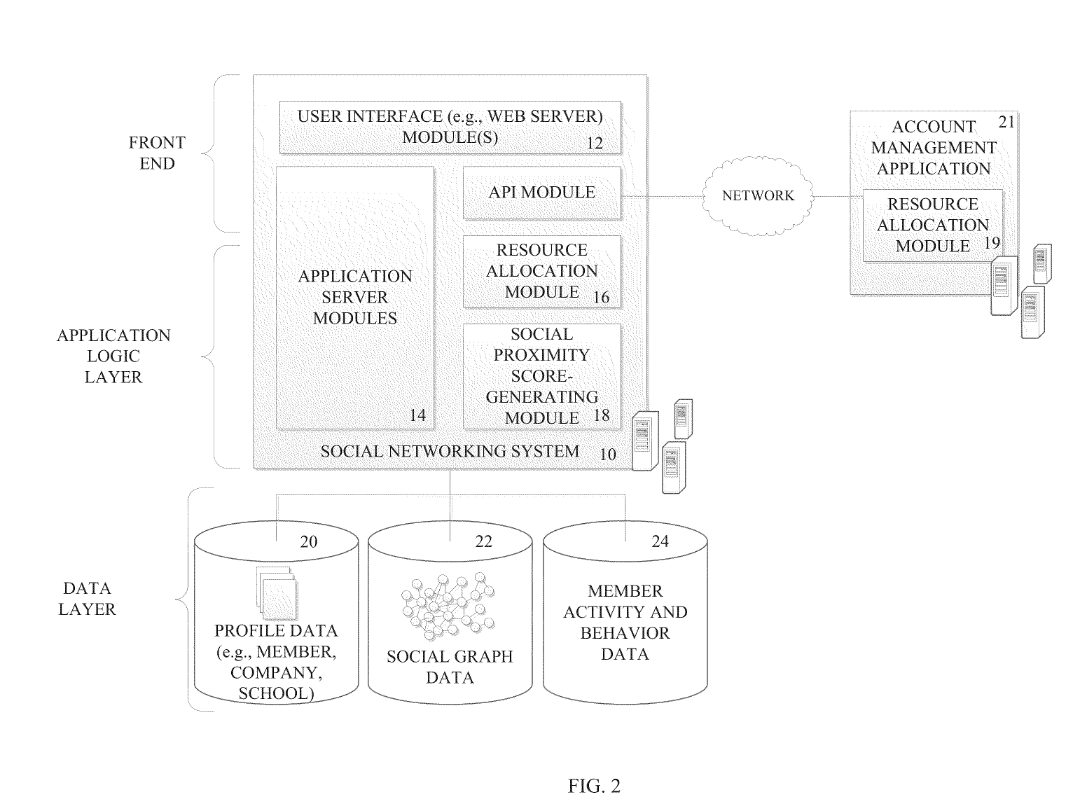

FIG. 2 is a block diagram showing the functional components of a social networking service, including a data processing module referred to herein as a social proximity score-generating module 18 (or, simply score-generating module), for use in computing or deriving social proximity scores. As shown in FIG. 2, the front end consists of a user interface module (e.g., a web server) 12, which receives requests from various client-computing devices, and communicates appropriate responses to the requesting client devices. For example, the user interface module(s) 12 may receive requests in the form of Hypertext Transport Protocol (HTTP) requests, or other web-based, application programming interface (API) requests. The application logic layer includes various application server modules 14, which, in conjunction with the user interface module(s) 12, generates various user interfaces (e.g., web pages) with data retrieved from various data sources in the data layer.

As shown in FIG. 2, the data layer includes several databases, such as a database 20 for storing profile data, including both member profile data as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 20. With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of following another member typically is a unilateral operation, and at least with some embodiments, does not require acknowledgement or approval by the member that is being followed. The various associations and relationships that the members establish with other members, or with other entities and objects, are stored and maintained within the social graph, shown in FIG. 2 with reference number 22.

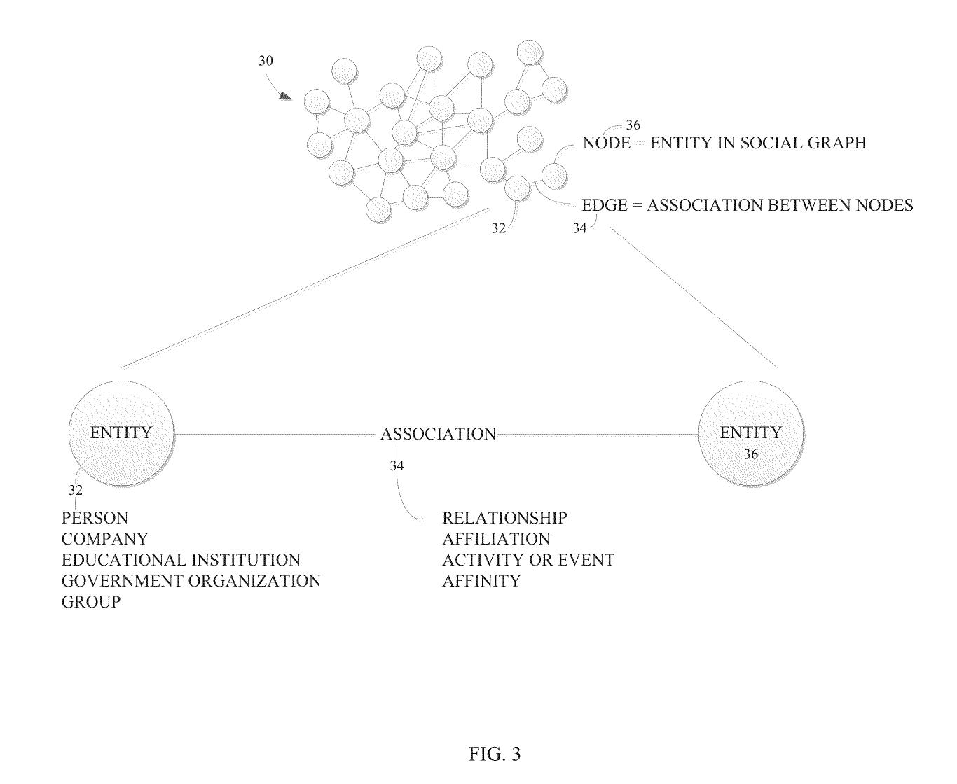

An example of a portion of a data structure 30 for modelling a social graph is shown in FIG. 3. As illustrated in FIG. 3, the graph data structure 30 consists of nodes connected by edges. For instance, the node with reference number 32 is connected to the node with reference number 36 by means of the edge with reference number 34. Each node in the graph data structure 30 represents an entity in the social graph. With some embodiments, any number of entity types may be included in the social graph. For example, as illustrated in FIG. 3, the entity types that exist in one implementation of a social graph, consistent with some embodiments of the invention, are: a person, a company, an educational institution (e.g., college, school or university), a government organization or entity, and a group (e.g., an online group, hosted by the social networking service, or some other third party server system, or a real-world organization, such as a professional organization.) The edges that connect any two nodes can represent a wide variety of different associations. For example, in general, an edge may represent a particular type of relationship, a particular affiliation, attendance at an activity or event, or some other affinity shared in common between two entities. For example, an edge connecting two nodes that represent people may be representative of a specific type of relationship between the two people, including a direct, bilateral connection between the two people. Similarly, in the case of a directed graph, an edge between two nodes representing people may indicate a “following” relationship, where one person has unilaterally subscribed to receive information about, or relating to, the other person. An edge connecting a first node, representing a person, with a second node, representing a company, may be representative of an employment relationship (current or previous) between the person and the company. Similarly, an edge connecting a first node, representing a person, with a second node, representing an educational institution, may represent or indicate that the person matriculated with or graduated from a particular school or university. Of course the list of associations 34 shown in FIG. 3 is by no means exhaustive, and any number of other association types may be mapped to the edges of a social graph data structure to indicate the association between entities in a social graph of a social networking service.

In addition to the edges having a particular type, representative of the nature of the relationship between two entities, each edge connecting two entities may be assigned an edge score to reflect the strength, or relevance, of the particular association or relationship that exists between the entities represented by the nodes. With some embodiments, the particular type of association or relationship represented by the edge may determine the edge score assigned to each edge. For example, if an edge represents a bi-lateral direct connection between two people, the score assigned to the edge may be higher than if the edge represents a “following” relationship, where one person has unilaterally taken action to “follow” another person. With some embodiments, the scores assigned to various edges may be algorithmically determined based on a wide variety of factors, including analysis of the social graph, member profile information, as well as various member activities and behaviors. For example, an edge score for an edge connecting two members of the social networking service may be based in part on the number of member profile attributes that the two members share in common. Similarly, an edge score for an edge connecting two members of the social networking service may be based in part on the two members sharing in common specific member profile attributes. Accordingly, the edge score for an edge connecting two members residing in the same geographical location, as indicated on their respective member profiles, may be higher than an edge score assigned to two connected members who live in different geographical locations. Similarly, an edge score for an edge connecting two members may be derived in part based on the number of mutual connections shared between the two members. In yet another example, an edge score may be algorithmically determined based in part on analysis of member activity and behavior data, including the frequency and recency of certain interactions between the members. For instance, if two members of the social networking service are directly connected with one another, and the two members frequently interact with one another, for example, by exchanging emails, exchanging messages (e.g., instant messages, text messages, etc.), conversing by telephone, sharing content, commenting on content items posted to a content stream or activity or content feed, and so forth, the edge score assigned to the edge connecting the two members in the social graph may be determined at least in part on the level (e.g., amount) of activity, as well as the timing (e.g., recency) of the activity, with more recent activity contributing more to the edge score. A time decay algorithm may be used to weight the contribution toward the edge score of an activity, based on when the activity occurred, such that activities occurring in the distant past influence the connection strength score less than recent activities.

Referring again to FIG. 2, the social networking service may provide a broad range of applications and services that allow members the opportunity to share and receive information, often customized or personalized to the interests of the member. As members interact with the various applications, services and content made available via the social networking service, the members' behavior (e.g., content viewed, links or buttons selected, messages responded to, etc.) may be tracked and information concerning the member's activities and behavior may be logged or stored, for example, as indicated in FIG. 2 by the database with reference number 24. This information may be used, for example, to determine the connection strength between members.

As illustrated in FIG. 2, the social networking system 10 includes what is referred to as a resource allocation module 16. The resource allocation module facilitates the allocation of resources (e.g., human resources, such as sales representatives) to various target entities, such as companies and other organizations. For instance, given a set of rule-based constraints, the resource allocation module 16 attempts to identify the most suitable person—that is, the person with the highest social proximity score—to be assigned to each of the target entities (e.g., customer account) while also satisfying all of the rule-based constraints. Accordingly, the resource allocation module 16 will request from the social proximity score-generating module 18 a set of social proximity scores for various member and target entity pairings. Upon receiving the set of social proximity scores for various member and target entity pairings, the resource allocation module 16 may automatically identify the best mapping of resources to target entities, such that all rule-based constraints are satisfied, and the persons with the highest social proximity scores are assigned to the target entities.

As illustrated in FIG. 2, with some embodiments, the resource allocation module 16 is integrated with the social networking system 10. When integrated with the social network system 10, users will generally access the resource allocation module via a client application (not shown) executing and residing on a client computing device. The client application may be a web browser-based application, or some other proprietary client application.

With some embodiments, the social proximity score-generating module 18 may be accessible to one or more resource allocation modules 17 that reside and execute on a computing device of a third-party—that is, some entity other than the entity that operates the social networking service. Accordingly, at least with some embodiments, the functionality of the social proximity score-generating module 18 may be made available via an application programming interface (API) module 19, such that third-party applications can request and receive social proximity scores over a network. For example, using an API, an application, such as an account management application 21, may be able to request the social proximity scores for particular members or set of members, identified by respective member identifiers.

With some embodiments, the resource allocation module uses one or more algorithms for automatically making resource allocation recommendations and/or decisions. For example, the resource allocation module (16 or 19) may initially allow a user (e.g., an administrator) to identify those members of the social network service who are also part of a team or group—such as all sales representatives for a particular business organization. In addition, the resource allocation module may allow a user to select or otherwise identify any number of target entities (e.g., companies, educational institutions, government organizations, and so forth). The target entities may represent existing customer accounts of the business organization, new accounts that are being targeted for business development, and so forth. The entities may be identified by some identifying information (e.g., a Dunn and Bradstreet company identifier) or selected based on a query indicating desired company attributes (e.g., size, industry, location, etc.). In any case, the resource allocation module 16 may use any number of optimization algorithms to map individuals (e.g., sales representatives) to target entities, where at least one mechanism by which resource allocation decisions are made is a social proximity score representing a measure of how socially connected a member is to a target entity. Accordingly, with some embodiments, the resource allocation module 16 may request that the social proximity score-generating module 18 is to compute or derive social proximity scores for each member in the group of members (e.g., the group of sales representatives). This may be done for any number of target entities (e.g., customer accounts). Once the social proximity scores for all of the sales representatives have been generated for all target entities, an allocation optimization algorithm may be used to make resource allocation recommendations and/or decisions. For instance, for each target entity, a list of the members meeting all of the specified criteria and having the highest social proximity scores may be presented.

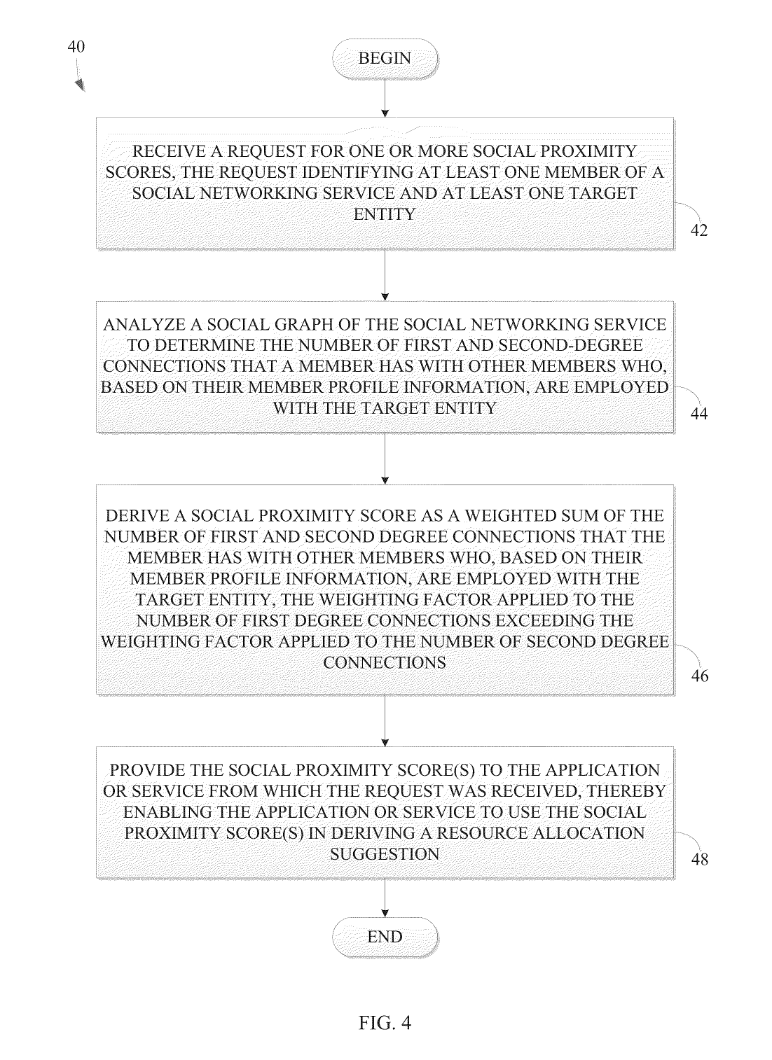

FIG. 4 is a flow diagram illustrating the various method operations that may be performed as part of a method for computing one or more social proximity scores, consistent with embodiments of the invention. The method begins at method operation 42 when the social proximity score-generating module receives a request for a set of social proximity scores, representing a measure of how socially connected a particular member is to a particular target entity. As such, the request may include information identifying the particular members and target entities for which the social proximity scores are being generated. With some embodiments, the request may include identifying information for each individual member and target entity, while in other embodiments, the members and target entities may be predefined and stored such that the request need only identify the pre-stored information.

At method operation 44, the score-generating module retrieves and analyzes a variety of social graph and member profile information to identify the connection paths between a member and any member that is employed with the target entity. In particular, with some embodiments, the connection paths of interest are first-degree connections, second-degree connections, and/or connections to members employed at the target entity in a particular capacity, as indicated by member profile information. The various connections may be tallied by their connection type or degree (e.g., first-degree connections, and second-degree connections) as well as connections that satisfy certain predefined criteria. For example, with some embodiments, when a member is connected to other members employed with the target, and those members have member profile information satisfying certain criteria (e.g., job title, job function, seniority level), those connections may be separately tallied. Furthermore, with some embodiments, each individual connection may be weighted to reflect a measure of the strength of the connection, as indicated by an edge score connecting two nodes in the social graph.

Next, at method operation 46, a social proximity score is computed or derived by combining the count of each category of connection, with one or more weighting factors applied to the count of connections for different categories. For example, first-degree connections may be weighted more heavily than second-degree connections. Similarly, connections with members satisfying certain criteria may be weighted to reflect the relative importance of such connections. The connection strength of each connection may be considered in determining the contribution of that connection, or type of connection, to the overall social proximity score. Finally, at method operation 48, the social proximity scores are provided to the application, service or functional module that initially made the request for the social proximity score or scores.

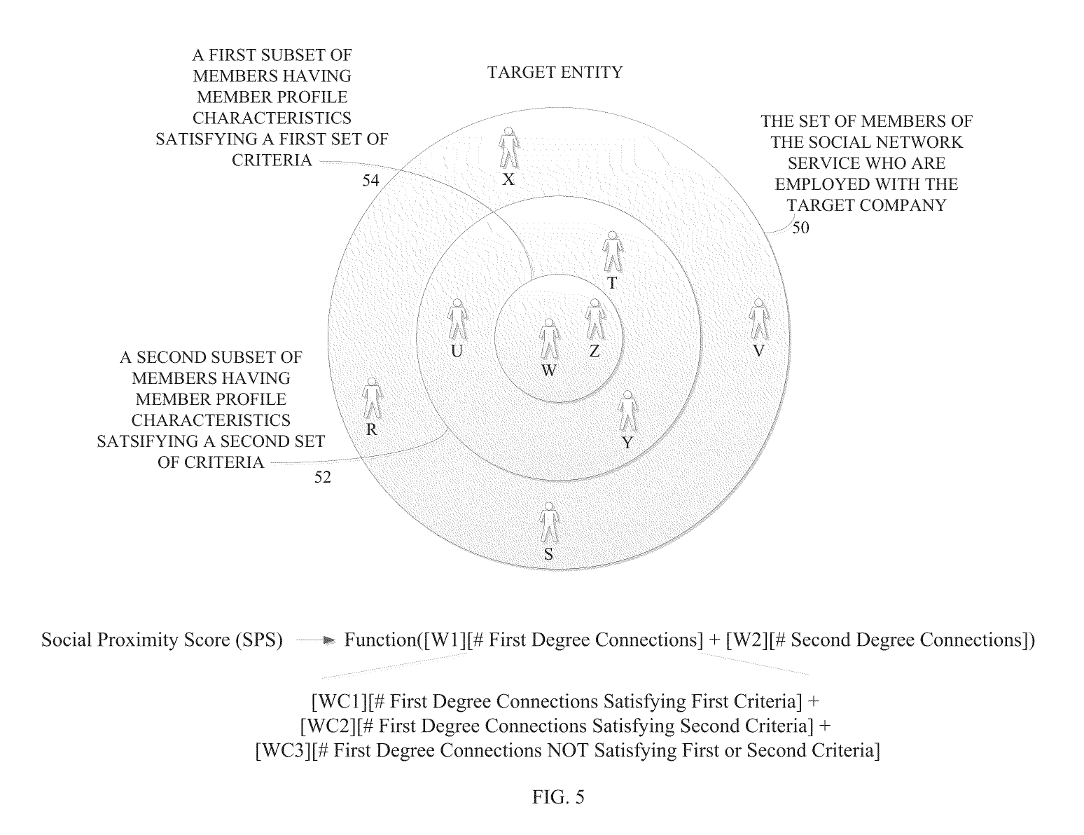

FIG. 5 is a diagram showing an abstract representation of a target entity (e.g., a company) with employees being members of a social networking service and being segmented by certain predefined criteria (e.g., job titles, job functions, seniority), consistent with some embodiments of the invention. For example, in the example of FIG. 5, the outermost circle with reference number 50 represents a set of members of a social networking service who, according to their member profiles, are currently employed with a target entity (e.g., a particular company). In this simplified example, this set of members includes members R, S, T, U, V, W, X, Y and Z.

The inner circle with reference number 52 represents a subset of the members defined by the circle with reference number 50. In particular, the subset of members represented by the inner circle with reference number 52 are those members of the social networking service who are both employed at the target entity and have member profile information that satisfies some predefined criteria. For example, the criteria may be that the member profiles of the members indicated a particular job title and job function. For instance, the subset of members defined by the inner circle with reference number 52 may be people who work at the target entity in a sales capacity, as indicated by a combination of their job title and job function. The subset of members satisfying the specified criteria includes members, T, U, W, Y and Z. These particular connections

The inner most circle, with reference number 54, represents a subset of all members of the social network service who are employed with the target entity. Specifically, the subset of members represented by the inner most circle includes members satisfying some second predefined criteria. Typically, these members will be key decision makers. For example, these members may be senior level employees working in a sales capacity, as indicated their member profiles. This subset includes members W and Z.

As indicated in the example formula with reference number 56, a social proximity score may be computed as the count of first-degree connections, weighted with a first weighting factor (W1), combined with a count of second-degree connections, weighted with a second weighting factor (W2). Of course, the second weighting factor, applicable to second degree connections, will typically be less than the weighting factor for first degree connections.

With some embodiments, the connections to members satisfying different criteria may be weighted accordingly, to reflect the importance of those connections relative to others. For example, the first degree connections that satisfy the first set of criteria (e.g., members U, T and Y) may be weighted with a weighting factor (WC1) to reflect there greater importance relative to others (e.g., R, S, V and X). Similarly, a connection to a member in the innermost circle—satisfying the second set of criteria—may be weighted in accordance with a second weighting factor (WC2) to indicate their greater importance. In this manner, a social proximity score for a member is computed.

With some embodiments, the total number of connections (particularly second-degree connections) that a member may have with other members employed at a target entity may be extremely high. Accordingly, with some embodiments, a logarithmic scale is used to deemphasize the relative impact that each additional connection may have to the social proximity score, when there are a large number of connections. Additionally, to normalize social proximity scores and provide for meaningful comparisons across target entities having different sizes (e.g., numbers of employees), with some embodiments the number of connections satisfying any particular criteria may be divided by the total possible number of members satisfying the criteria. In this way, the percentage of connection types is used as opposed to the absolute number of connections. Of course, in such a scenario the logarithm operation would be performed on both the numerator and denominator.

Although not shown in the simplified example of FIG. 5, with some embodiments, each individual connection may be weighted in accordance with a connection strength score that is algorithmically determined and maintained as part of the social graph of the social networking service. Accordingly, if a member frequently interacts with a member employed with the target entity, the connection strength score for the member may be higher, ultimately increasing the social proximity score for the particular member and target entity pairing.

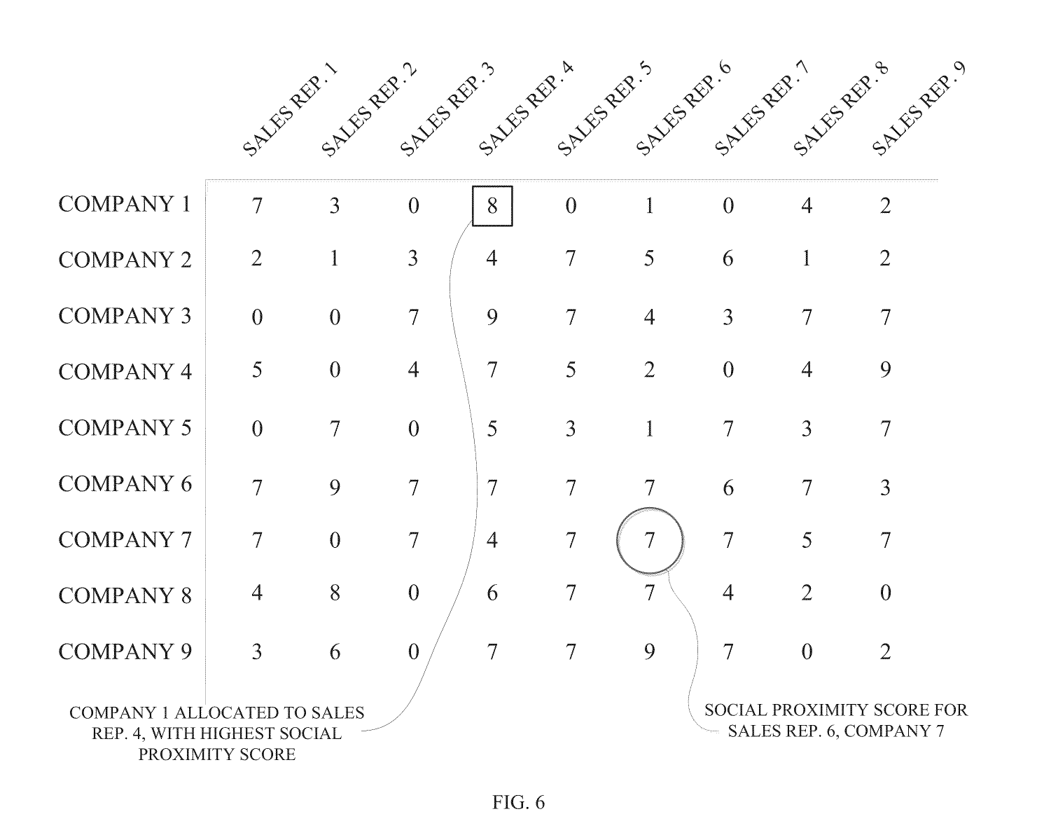

FIG. 6 is a table illustrating an example of the output data provided by a social proximity score-generating module, consistent with some embodiments of the invention. As illustrated in FIG. 6, with some embodiments, a social proximity score-generating module outputs a set of social proximity scores for each pairing of a member of the social networking service (e.g., a sales representative) and a company. As shown in this simplified example of FIG. 6, the social proximity scores are normalized to an integer number between one and ten. Of course, in various embodiments, different normalization techniques may result in scores covering different ranges.

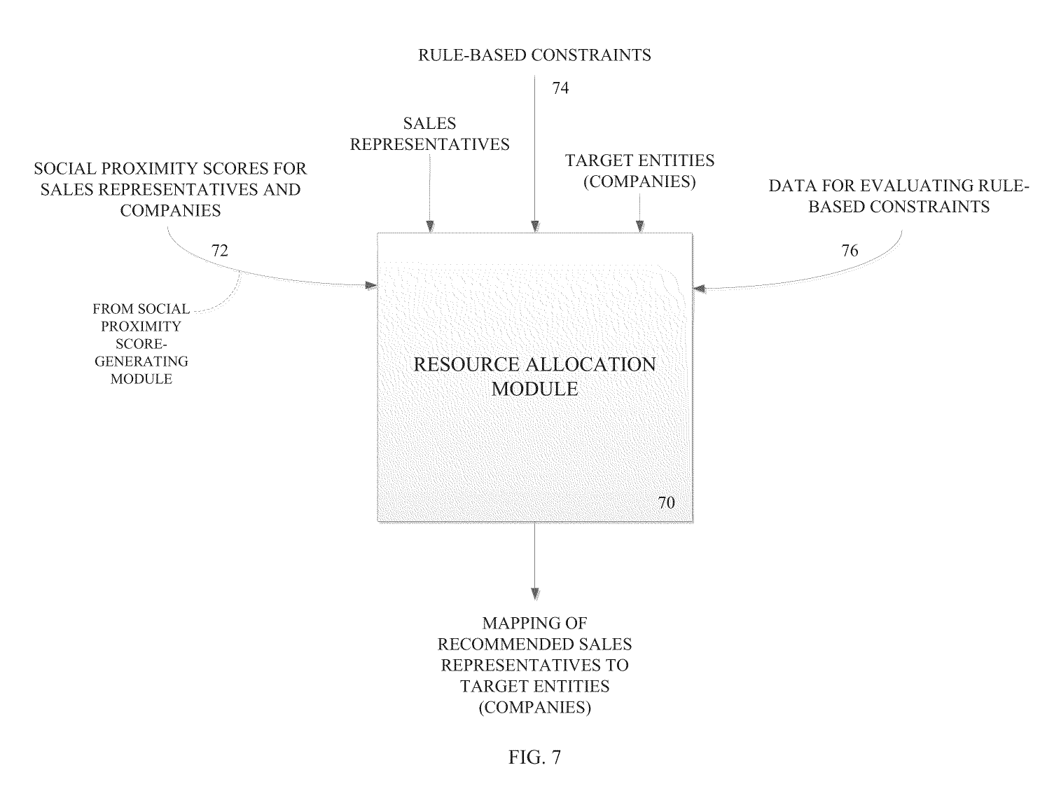

FIG. 7 is a block diagram illustrating an example of the inputs and outputs of a resource allocation module, consistent with some embodiments of the invention. As shown in FIG. 7, the resource allocation module 70 receives as input the output of the social proximity score-generating module (e.g., as shown in FIG. 6)—that is, the social proximity scores for a set of sales representatives and target entities. The social proximity scores may be retrieved from a database, accessed from a file, or obtained some other way. In addition, the resource allocation module 70 accesses a set of rule-based constraints 74, which may be configured by an administrator. Finally, the resource allocation module 70 receives as input a variety of data for use in evaluating the rules of the rule-based constraints.

While the number and nature of the particular rule-based constraints used in allocating resources will vary considerably and are highly implementation specific, some of the rule-based constraints include, but are certainly not limited to the following. One constraint involves one or more measures of revenue opportunity, sometimes referred to as the size of prize, or total addressable market. For example, when allocating a set of customer accounts to a particular sales representative, there may be a desired range of projected revenue that each sales representative is to be assigned and responsible for. Accordingly, this rule-based constraint may specify that the sum of all revenue opportunity from all accounts assigned to a particular sales representative should be no less than some lower threshold (a floor) and no higher than some higher threshold (a ceiling). Similarly, in some instances, the individual representatives may be assigned to different tiers or levels, such that the most experienced and efficient representatives are assigned to a highest tier, while the less experienced and less efficient representatives are assigned to a lower level or tier. Accordingly, one or more rules may dictate a minimum and maximum revenue opportunity for each tier or level, such that an account representing a particularly large revenue opportunity is not to be assigned to a sales representative who is in a lower tier or level, and similarly, an account representing a smaller revenue opportunity is not to be assigned to a sales representative in a higher tier or level. In some instances, a measure of the likelihood or probability of success for a particular account may also be taken into consideration. Accordingly, the revenue opportunity may be weighted based on the likelihood of realizing the revenue.

Other constraints may define a minimum number of accounts, a maximum number of accounts, or a range of accounts that are to be assigned to any one sales representative, or any one sales representative in a particular tier or level. Another constraint may be a geographical region. For example, in many instances, various members of a sales team will be assigned to different geographical regions. In allocating accounts to sales representatives, a rule-based constraint may dictate that a particular sales representative is only to be allocated accounts (e.g., target entities) in a particular geographical region.

Of course, with some embodiments, more complex rule-based constraints may be used. In particular, the rule-based constraints may provide for various exceptions—particularly, in situations where a sales representative has a social proximity score for a particular company or account that exceeds some threshold. For example, a rule may dictate that certain sales representatives are only to be allocated customer accounts within a given geographical region, unless their social proximity score for a particular customer account exceeds some threshold score. In some instances, various rule-based constraints may be defined to be applicable to all sales representatives, all representatives in a particular tier or level, all representatives within a particular geographical industry, or all representatives working with a particular internal business unit.

With a set of rule-based constraints defined, the resource allocation module 70 will allocate the target entities to the various sales representatives, such that the social proximity scores are maximized across all of the allocated representatives, while simultaneously ensuring that all rule-based constraints are satisfied. As such, the target entities (companies) are allocated to individual representatives, such that all rule-based constraints are satisfied, and the sales representatives with the highest social proximity scores for respective target entities are assigned to those entities.

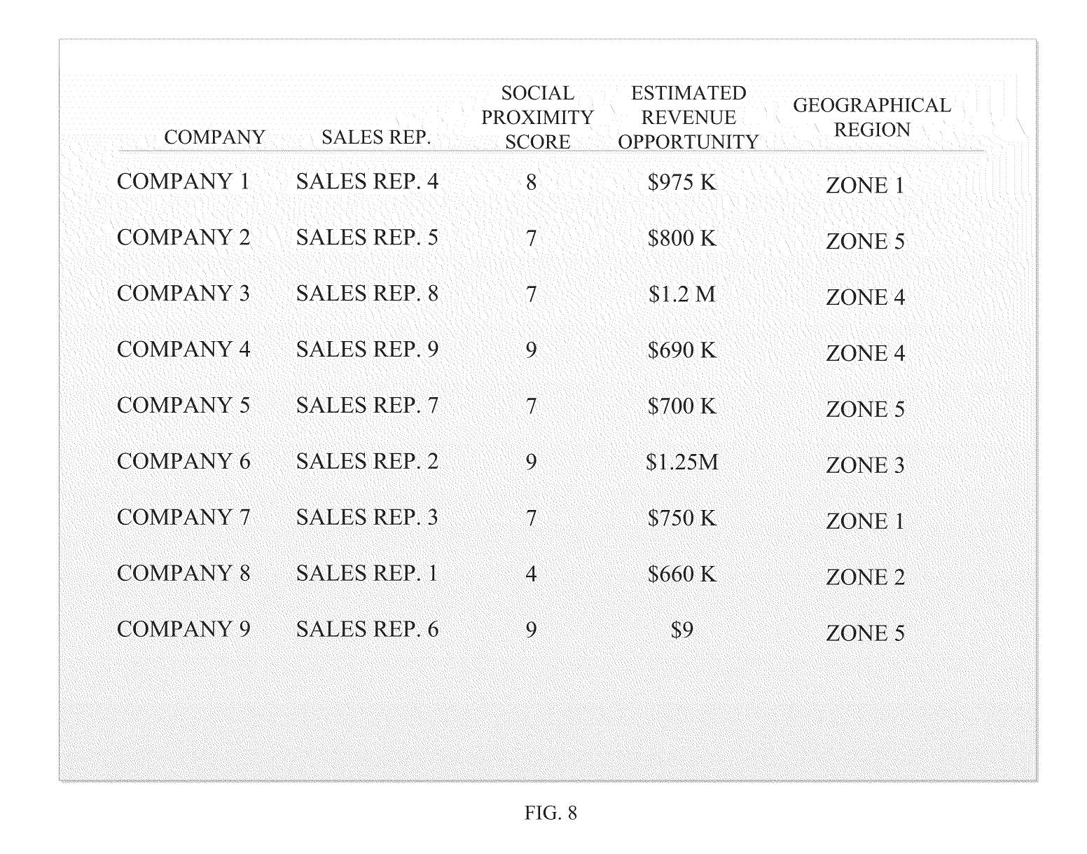

FIG. 8 is a table illustrating an example of the output of a resource allocation module, according to some embodiments. In this simplified example of FIG. 8, each company in a set of companies has been allocated to a corresponding sales representative. Of course, in many instances, each sales representative will be assigned or allocated to a large number of companies. Additionally, a wide variety of other information may be displayed with the mapping of company to sales representative.

### Using Social Proximity Scores in Recruiting and Hiring

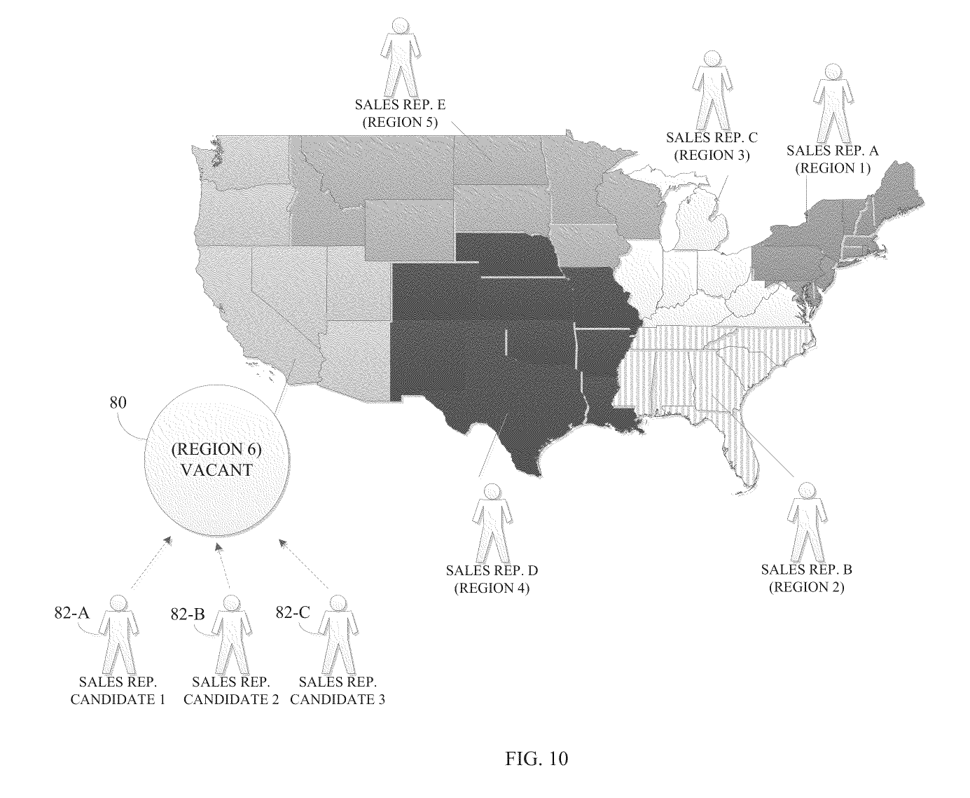

In addition to using individual social proximity scores for allocating resources (e.g., assigning customer accounts to sales representatives), as set forth above, with some embodiments social proximity scores are used to facilitate computer-based processes associated with recruiting and hiring. For example, consider a scenario such as that illustrated in FIG. 10 where individual sales representatives on a sales team of a business organization have been allocated to various customer accounts within various defined territories or regions. In this simplified example, six regions have been designated such that each region has a set of customer accounts for which the sales representative assigned to that region is responsible. When a sales representative assigned to a particular region leaves the business organization to join a different organization, it becomes necessary to either reallocate the customer accounts for that particular region 80 (e.g., region 6 in FIG. 10) to other sales representatives on the sales team, or alternatively, to hire a new sales representative to take the place of the sales representative who has departed. In the example presented in FIG. 10, the sales representative for the region labelled as “region 6” has departed, and the business organization is now considering three new sales representative candidates 82-A, 82-B and 82-C for replacing the departed sales representative.

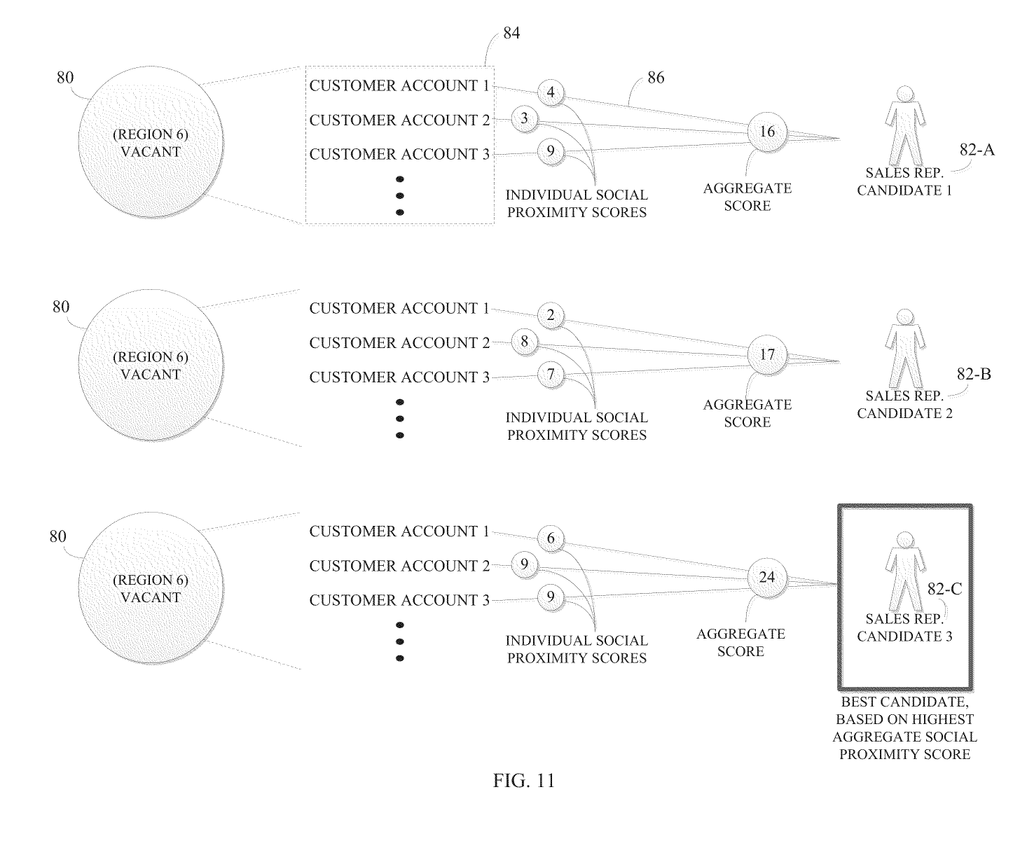

Referring now to FIG. 11, an example of how social proximity scores may be used in evaluating candidates, who are members of a social networking service, for an open sales representative position is presented. For instance, as illustrated in FIG. 11, the region having the departed sales representative (e.g., “region 6” with reference number 80) is associated with a set of customer accounts 84 (e.g., “Customer Account 1 through 3”). For purposes of this example, only three customer accounts are shown. However, in practice, any number of accounts may be associated with a particular region, or be assigned to a particular sales representative, or be defined as being in a particular set or group of accounts. Generally, various sets of customer accounts are defined and maintained, for example, in a database, via a customer account management application. In this particular example, these customer accounts are the entities (e.g., company, educational institution, government entity or organization, non-profit organization, or any other type of organization) for which the departed sales representative of region 6 was previously responsible. However, in other instances, accounts may be combined to define a group of accounts for any number of reasons. Furthermore, the customer accounts may be current customers of the business organization, or potential customers of the business organization. Accordingly, in some instances, it may be desirable to define or identify a group of accounts that represent potential new customer accounts, as opposed to existing customer accounts. In this way, the social proximity scores can be used not only for assessing a sales representative as a replacement for a departed sales representative, but also for assessing sales representatives in the context of market expansion and/or growth opportunity situations.

In any case, for each combination of a candidate for the open sales representative position and a customer account in the set of customer accounts, an individual social proximity score is generated. For example, as illustrated in FIG. 11, sales representative candidate 1 has a social proximity score of four with respect to the entity representing customer account 1 (as shown by the line with reference number 86). Similarly, sales representative candidate 1 has a social proximity score of three with respect to the entity representing customer account 2. As described in greater detail above, the social proximity scores are derived by analyzing the relationships that exist, as memorialized in a social graph of a social networking service, between a sales representative candidate and other members of the social networking service who are associated with (e.g., employed by) an entity or organization representing a customer account.

Subsequent to generating the individual social proximity scores, an overall or aggregate social proximity score may be derived. The specific algorithm used in deriving the social proximity score for a particular customer account may be customized, as described above, such that when a candidate has a connection or connections to persons employed in specific roles with the particular target organization, or having certain job titles identifying those persons as key decision makers in the target organization will positively impact (e.g., increase) the social proximity score for that particular candidate. In this example, sales representative candidate 1 has an overall or aggregate social proximity score of sixteen (“16”) for the entire set of accounts, while sales representative candidate 2 has an aggregate social proximity score for the set of accounts of seventeen (“17”). Finally, for the particular set of customer accounts assigned to the region referenced in FIG. 11 as “region 6,” sales representative candidate 3 is the most socially connected candidate of the three candidates, having an aggregate social proximity score of twenty-four (“24”).

With some embodiments, any number of various algorithms may be used to combine the individual social proximity scores into an aggregate or overall score. For example, with some embodiments, when combining individual social proximity scores, the social proximity score for a particular customer account may be weighted in relation to some other attribute or characteristic of the customer account that is generally representative of the importance of the account to the business organization. For example, if a particular customer account has historically represented a sizable portion of revenue for the business organization, then a weighting factor may be used to increase the contribution of the individual social proximity score for that particular customer account to the overall or aggregated social proximity score. Similarly, if a particular potential customer account is perceived as possibly representing a sizeable amount of future revenue for the business organization, the social proximity score for that particular potential customer account may also be weighted accordingly. As such, with some embodiments, a weighting scheme may be used such that one of several different weighting factors is applied to each social proximity score based on such factors as, for example, the amount of revenue that is expected to be earned from a particular customer account, which may be based on historical revenue or some forward looking metric. With some embodiments, potential accounts may be weighted differently than actual or existing customer accounts, giving preference to the higher likelihood that an existing customer will remain an active customer account. Similarly, with some embodiments, a separate aggregate social proximity score may be derived for both potential customer accounts (e.g., an account for which there is not current sales history) and actual or existing customer accounts (e.g., an account for which there is a recent sales history) to reflect a candidate's social connectedness to each type (potential and actual) of customer account.

With some embodiments, one or more other measures of central tendency, such as the mean, median or mode, of all social proximity scores may also be derived. Accordingly, with some embodiments, using one or more of the mean, median and mode, the information presented may indicate whether a candidate's overall social proximity score for a set of customer accounts is inflated due to a strong relationship (and thus high social proximity score) for one particular account, with lower scores for the remaining accounts.

Skilled artisans will recognize that the example presented in connection with FIGS. 10 and 11 has been simplified considerably as an aid in conveying the inventive concepts and to avoid obscuring the inventive concepts with unnecessary detail. In various alternative embodiments, the set of accounts for which the aggregate score is to be generated may be manually defined by a member of the organization that is looking to hire a sales representative. Similarly, with some embodiments, a wide variety of other attributes and factors may be considered and presented in various user interfaces to facilitate the hiring and recruiting processes. With some embodiments, the individual social proximity scores may be normalized and/or standardized, consistent with techniques described above, and of course may be presented consistent with some scale that is different from that illustrated in FIG. 11.

With some embodiments, various interactive user interfaces may be presented to allow a user with the ability to very quickly drill down to obtain information about various factors and relationships contributing to the social connectedness of a particular candidate to a particular target entity at greater levels of detail. For example, an initial user interface may present a high level view of the individual candidates, providing information identifying the candidates with select information from their respective member profiles and their aggregate social proximity scores for the selected set of customer accounts. By selecting a particular candidate from the initial user interface, the user may be able to quickly obtain information specifying individual social proximity scores for particular customer accounts. Furthermore, by selecting a particular customer account, the user may be able to view specific relationships between a candidate and certain key employees of an organization representing a particular customer account. Accordingly, a hiring and/or recruiting application consistent with some embodiments may provide users not only with high level information indicating the overall level of social connectedness that a particular candidate has with respect to a particular set of customer accounts, but the application may provide an interactive interface enabling a user to very quickly drill down to view detailed information about specific relationships the candidate has, and other information that ultimately affects the aggregate social proximity score of the candidate.

With some embodiments, one or more steps may be taken to ensure that expectations around data privacy are properly addressed and managed. For instance, as part of a job application submission process or work flow, a job candidate may be prompted to provide a hiring organization express authorization to access information about his or her connections generally, and in some instances, information specifically relating to his or her connections or relationships with people employed at certain target entities of interest to the hiring organization. In other instances, a member of a social networking service may provide express authorization to have his or her relationship information analysed and presented in limited circumstances (e.g., only to certain persons, companies, or entities, and/or only for certain purposes.) Accordingly, in some instances, only after such authorization has been received from a job candidate will it be possible for a hiring organization to receive detailed information about a candidate's specific relationships with certain target entities representing existing or potentially new customer accounts. This specific information may include the identities of the particular people with whom a job candidate has established a direct connection via the social networking service. With some embodiments, when express authorization has not been provided, data privacy concerns may be addressed by preserving the anonymity of the specific persons to whom a job candidate is connected. For example, this may be achieved by only presenting an aggregate or overall social proximity score, without any option for drilling down to a more detailed view of an individual social proximity score (e.g., for a single entity) and/or the specific relationships (connections) with other members on which a score is ultimately derived. With some embodiments, anonymity may be preserved by providing an aggregate or overall social proximity score for a set of customer accounts, only when the number of individual accounts in the defined group of accounts is sufficiently large, for example, exceeding some minimum threshold number. In this way, an aggregate social proximity score cannot be used to infer the existence or nonexistence of relationships to specific person and/or entities, but instead, represents a higher-level measure of a candidate's overall social connectedness to the group of accounts.

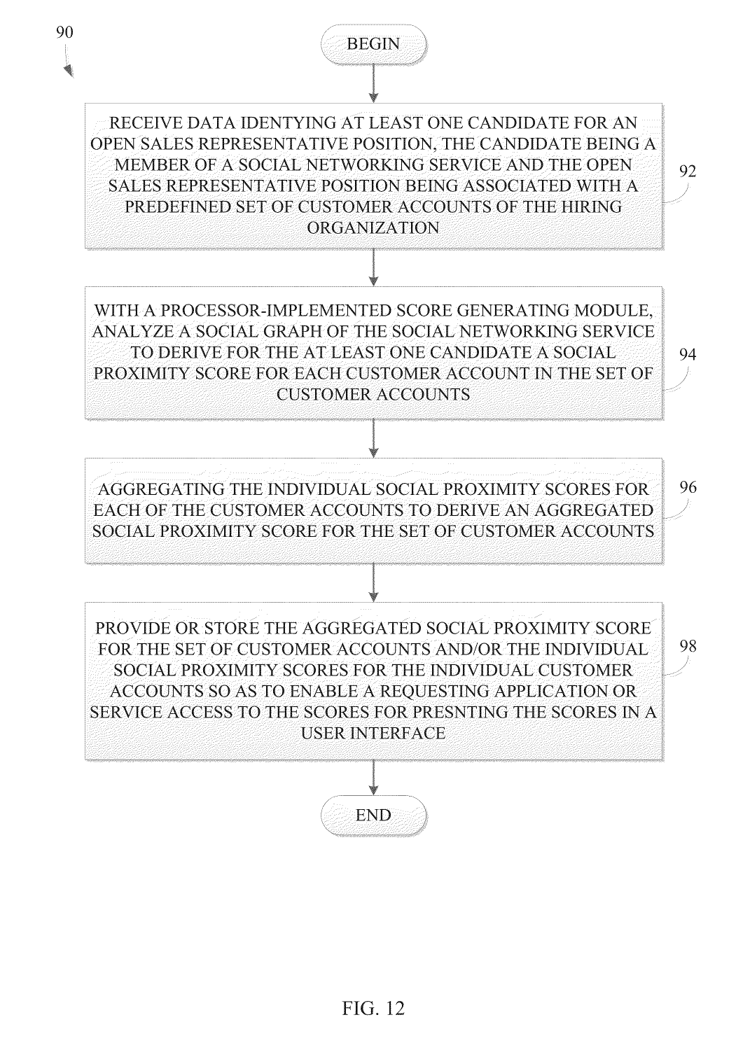

FIG. 12 is a flow diagram illustrating the operations of a method for deriving and presenting an aggregate social proximity score for a candidate being considered for an open sales representative position that is associated with a set of customer accounts, according to some embodiments. First, at method operation 92, a user—typically a recruiter or hiring manager of a hiring organization—interacts with a user interface of a software application to indicate that a particular member of a social networking service is a candidate for an open sales representative position with the hiring organization. Accordingly, information identifying at least one candidate will be received as a result of the user interacting with a user interface of the software application. The information identifying the candidate may be received in any number of ways. For example, with some embodiments, the user may simply type the name of the candidate, provide a unique member identifier for the candidate, select a particular graphical user interface element displayed in association (e.g., next to, or near) other information identifying the candidate such as information presented via the candidate's member profile page. In addition, the received information will also identify a particular set of customer accounts of the hiring organization for which an aggregate social proximity score is to be derived for the candidate. In some instances, the particular set of accounts may be associated with a particular geographical region, or an existing job opening or listing for a sales representative. Accordingly, with some embodiments, the information received may simply be some kind of identifier identifying the set of customer accounts. Similarly, the information may identify an existing sales representative position to be filled, where the open position is already associated with a predefined set of customer accounts.

In any case, subsequent to receiving the information at method operation 92, a score generating-module is invoked to generate for the candidate a social proximity score for each customer account in the set of customer accounts. The score-generating module may be invoked manually (e.g., via a user interacting with a graphical user interface element of a user interface), or automatically in response to receiving the information identifying the candidate. The social proximity scores for the candidate and the individual accounts are generally derived consistent with the techniques described above. For instance, the social proximity scores for each customer account are derived based at least in part on analyzing and identifying the connections (both the nature and number) that the candidate has to other members of the social networking service who are associated with (e.g., employees of) an organization representing the customer account in the social graph of the social networking service, with connections to certain members (e.g., employees with certain job titles, etc.) contributing more to the calculation of the individual social proximity score.

Once the individual social proximity scores for each customer account in the set of accounts has been derived (or if previously derived, once retrieved), at method operation 96 an overall or aggregate social proximity score is derived for the candidate and the specified set of customer accounts. In general, the aggregate social proximity score may be generated by simply summing the individual scores, taking an average or arithmetic mean of the scores, calculating a weighted combination of the individual scores where the weighting factors may be based on some metric representing the importance of the particular account to the hiring organization, or some other similar algorithm.

Finally, at method operation 98, the aggregate social proximity score for the set of customer accounts, and in some instances the individual social proximity scores for each individual customer account, are stored or otherwise provided to a an application or service so that the application or service can present the information in a user interface. With some embodiments, the aggregate social proximity scores for each of several candidates may be presented together with additional member profile information for each candidate, thereby providing a simple view of relevant information that is typically used in the hiring decision making process.

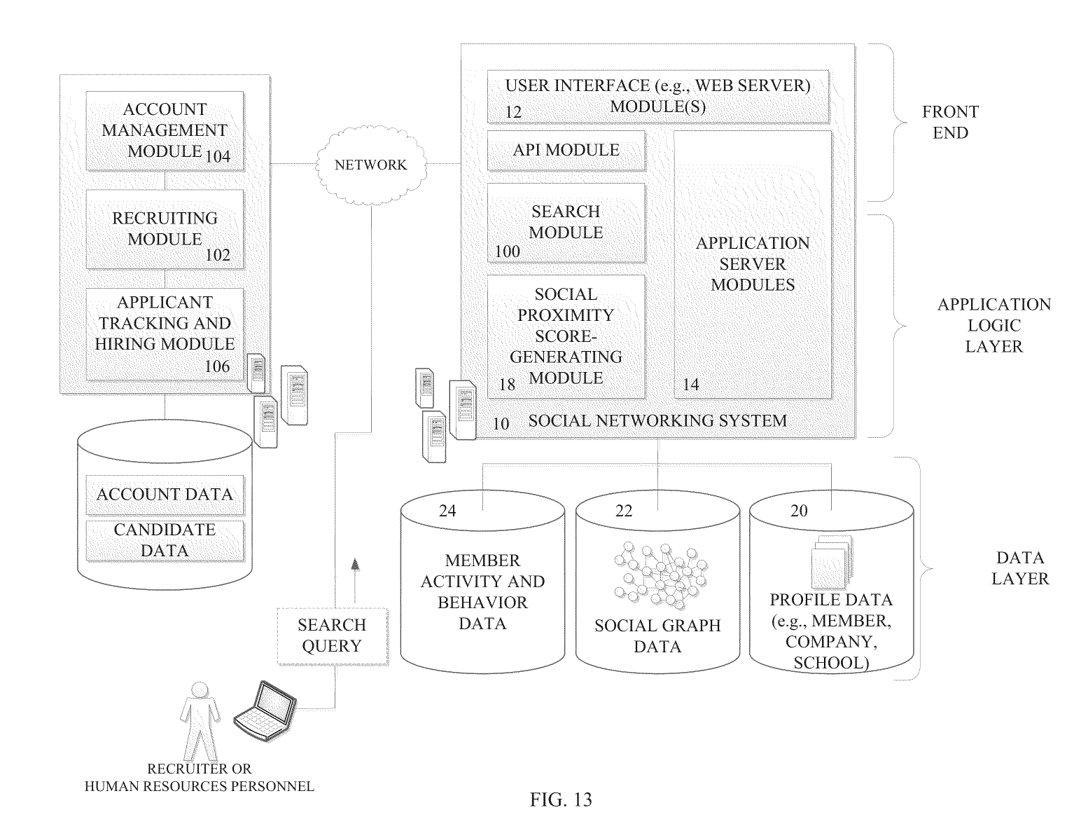

FIG. 13 is a block diagram showing the functional components of a social networking service, including a data processing module referred to herein as a social proximity score-generating module for use in deriving an aggregate social proximity score representing a measure of how socially connected a member is to a set of entities (e.g., companies) representing customer accounts of a business organization, consistent with some embodiments of the invention. Generally, the functional components shown in FIG. 13 with the same reference numbers as their counterparts shown in FIG. 2 perform the same or similar functions. However, the social networking system of FIG. 13 includes a search module 100, which was not shown in the system illustrated in FIG. 3. With some embodiments, the search module 100 operates in conjunction with a recruiting module 102 and/or other applications that might provide a front-end interface for a search service. With some embodiments, the search module 100 supports search queries that include as one component of the search query a social proximity score requirement. For example, a search query may specify a minimum social proximity score that a member is to have with respect to a particular entity or organization, representing a particular customer account. Similarly, a search query may specify a minimum aggregate social proximity score that a member is to have with respect to a predefined set of entities or organization, representing a set of customer accounts. With some embodiments, a search query may specify an average (mean), median or mode of social proximity score for a set of entities or organizations representing a set of customer accounts. Accordingly, the search module 100 can facilitate searching member profiles to identify members of the social networking service who satisfy a wide variety of specified attributes, including social proximity scores for a particular entity or organization, as well as certain aggregate social proximity scores for a predefined set of entities or organizations.

In the example of FIG. 13, the recruiting module 102 may provide various user interfaces enabling a recruiter or other hiring manager to generate a search query by specifying certain desirable member attributes. For example, a recruiter may craft a search query by specifying an industry in which a member should have worked, a level of seniority for a member, a job title, a school or set of schools from which the member should have graduated, and so forth. With some embodiments, the recruiter can specify as part of the query a minimum aggregate social proximity score for a set of accounts. For example, by specifying a minimum aggregate social proximity score for a set of accounts, the recruiter is able to identify those members of the social network service who not only satisfy the desirable characteristics of the candidate being sought, but also those members who, based on their existing relationships as memorialized in the social graph of the social network service, are already acquainted and familiar with the organizations and people that make up a portion of the customer base of the hiring organization. Accordingly, the search results will include only members of the social networking service who satisfy the recruiter-specified search criteria, including an aggregate social proximity score that meets or exceeds that specified by the recruiter, indicating a minimum level of social connectedness to the entities or organizations associated with a defined set of customer accounts of the organization on behalf of which the search is being performed.

With some embodiments, the set of customer accounts may be defined by a user of the account management module 104. For example, the account management module 104 may be used to allocate customer accounts to sales representatives of the organization, and additionally may provide a means to designate a set of customer accounts as being in a group, for purposes of performing a candidate query and deriving an aggregate social proximity score.

With some embodiments, the applicant tracking and hiring module 106 provides enables a hiring organization to track candidates that have been identified. Accordingly, via the applicant tracking and hiring module 106, a recruiter or hiring manager may specify the names of various candidates being considered for an open sales representative position, and request that an aggregate social proximity score for the candidates be derived and presented, for example, consistent with the method 90 illustrated in FIG. 12.

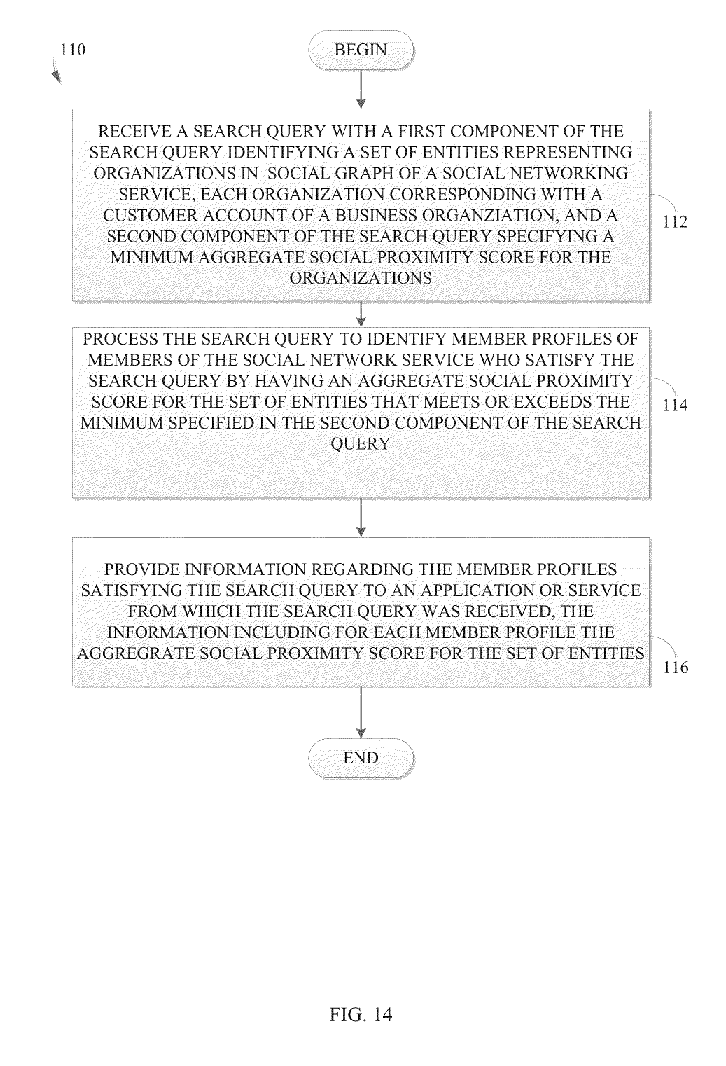

FIG. 14 is a flow diagram illustrating the operations of a method 110 for receiving and processing a search query, where at least one component of the search query is a minimum aggregate social proximity score for a set of customer accounts. Consistent with the method 110, a user (e.g., a recruiter) interacts with a search user interface and specifies various attributes that are desired in a candidate for a particular open position, or positions. For example, the recruiter may specify a set of schools from which an ideal candidate has graduated. Similarly, the recruiter may specify a number or range of years of experience, an industry, job title, skills possessed by the member and so on. In addition, the recruiter may include as a component of the search query some information that identifies a set of entities representing organization that are represented in a social graph of the social networking service. For example, these entities may be customer accounts (actual or potential) of the business organization. The set of accounts may be a set of accounts that had been allocated to a sales representative who has recently departed the business organization on whose behalf a new candidate is being recruited. Alternatively, a user may have manually defined the set of entities representing the customer accounts. In any case, in addition to the set of entities, the recruiter may specify as a component of the search query a minimum aggregate social proximity score that a candidate should have in order to qualify for consideration for the open sales representative position. The aggregate social proximity score represents a measure of overall social connectedness between the potential candidate, and members of the social networking service who have member profiles indicating employment at a particular entity in the set of entities. Accordingly, if a potential candidate has established connections with persons who are associated with the customer accounts represented by the recruiter-specified set of entities, that persons aggregate social proximity score may be higher than others who do not have such connections. Accordingly, at method operation 112, the search module or engine receives the search query, including the information identifying the set of entities, and the minimum aggregate social proximity score.

At method operation 114, the search module or engine processes the search query to identify member profiles of the members of the social networking service who satisfy the various attributes or parameters specified in the search query. In particular, the search engine will identify members who have an aggregate social proximity score that meets or exceeds the recruiter—specified minimum score for the set of identified entities that represent the customer accounts of the hiring business organization.

Finally, at method operation 116, various information from the identified member profiles, including the aggregate social proximity scores, are provided to the application or service from which the search query was received. Accordingly, a recruiter can identify members of a social networking service who have profiles that satisfy a wide variety of requirements, including a minimum level of social connectedness to a certain set of organizations that represent business accounts of the hiring organization.

With some embodiments, the order of the member profiles presented in the search results may be affected, at least in part, by the corresponding aggregate social proximity scores. For instance, member profiles having higher aggregate social proximity scores for the set of customer accounts may be presented more prominently in the search results—typically higher in the search results, and/or on the first page when the search results span more than one page. With some embodiments, a recruiter may additionally specify an average social proximity score, or a minimum social proximity score for any one particular customer account. Similarly, with some embodiments, a recruiter may not specify a minimum aggregate social proximity score, but the information may be provided with each member profile that otherwise satisfies the search query.

In the example presented in FIG. 14, the set of entities for which an aggregate social proximity score is to be derived is communicated as part of the search query. Similarly, the minimum aggregate social proximity score is communicated as part of the search query. In some alternative embodiments, these search query parameters may be predefined (e.g., at the search module 100 or the social proximity score-generating module 18), such that the search query only includes the particular member profile attributes of interest to the searcher. When the search is processed at the search module 100, the search module can access the additional search parameters to derive the aggregate social proximity score for each member profile that otherwise satisfies the search query. Accordingly, with some embodiments, the aggregate social proximity score for each member profile that satisfies a search query may be used in ranking and ordering the respective member profiles when presenting the member profiles in a search results user interface.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

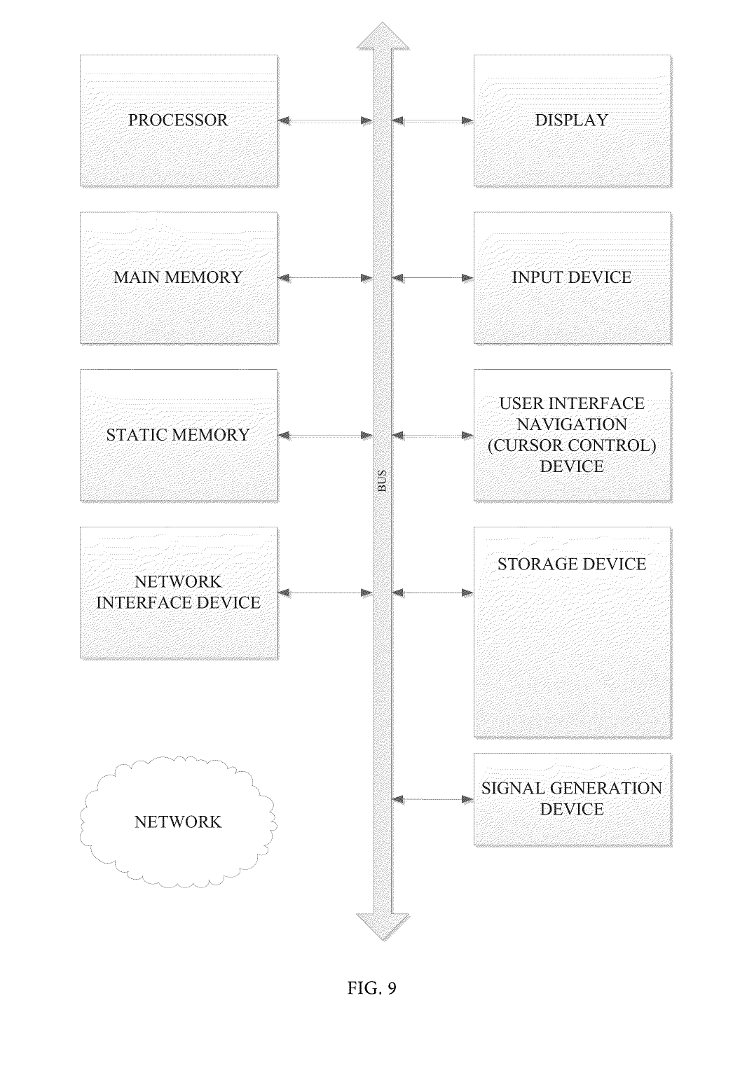

FIG. 9 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method comprising:
receiving data identifying a candidate for an open sales representative position, the open sales representative position associated with a set of existing customer accounts;
with a processor-implemented score-generating module, i) deriving for each of the existing customer accounts a social proximity score representing a measure of how socially connected the candidate is to an entity representing a customer account, the social proximity score derived at least in part based on analysis of a social graph maintained by a social networking service, and ii) aggregating individual social proximity scores for the existing customer accounts to derive an aggregated social proximity score representing a measure of how socially connected the candidate is to the set of existing customer accounts; and
presenting information identifying the candidate along with the aggregated social proximity score of the candidate.

2. The method of claim 1, further comprising:
prior to receiving the data identifying the candidate, receiving data identifying a set of entities representing the set of existing customer accounts, with each entity in the set of entities being represented in a social graph of a social networking service.

3. The method of claim 1, further comprising:
presenting an individual social proximity score representing a measure of how socially connected the candidate is to a particular entity representing a particular customer account.

4. The method of claim 1, further comprising:
deriving one or more measures of central tendency for the respective social proximity scores of the existing customer accounts to include a mean, mode and/or median social proximity score; and
presenting one or more of the measures of central tendency with the information identifying the candidate.

5. The method of claim 1, further comprising:
presenting information identifying each of a plurality of candidates for the open sales representative position; and
presenting with each candidate an aggregated social proximity score representing a measure of how socially connected a respective candidate is to the set of existing customer accounts.

6. The method of claim 1, further comprising:
determining that an individual social proximity score for a particular customer account in the set of customer accounts is less than a predefined threshold score established for the particular customer account; and
presenting with the information identifying the candidate additional information indicating that the candidate has a social proximity score for at least one customer account in the set of customer accounts that is less than the predefined threshold.

7. The method of claim 1, further comprising:
determining the number of social proximity scores for customer accounts in the set of customer accounts that exceed a predefined threshold score established for each customer account; and
presenting with the information identifying the candidate additional information indicating the number of social proximity scores that exceed the predefined threshold score established for each customer account.

8. The method of claim 1, wherein the social proximity score for a customer account is derived as a weighted combination of the number of first-degree and the number of second-degree connections that the candidate has with other members of the social networking service who have member profile information i) indicating current employment with an entity representing the customer account, and ii) satisfying some predefined criteria established specifically for the customer account.

9. The method of claim 8, wherein the member profile information satisfying some predefined criteria includes member profile information indicating that a member having member profile information indicating current employment with the organization representing the customer account has a job title matching any one of a plurality of predefined job titles.

10. The method of claim 8, wherein the member profile information satisfying some predefined criteria includes member profile information indicating that a member having member profile information indicating current employment with the organization representing the customer account has a job function matching any one of a plurality of predefined job functions.

11. The method of claim 1, wherein the member profile information satisfying some predefined criteria includes member profile information indicating that a member having member profile information indicating current employment with the organization representing the customer account has a seniority level that meets or exceeds some predefined seniority level.

12. A non-transitory computer readable storage medium storing instructions thereon, which, when executed by one or more processors of one or more computers, cause the one or more computers to:
receive data identifying a candidate for an open sales representative position, the open sales representative position associated with a set of existing customer accounts;
derive for each of the existing customer accounts a social proximity score representing a measure of how socially connected the candidate is to an entity representing a customer account, the social proximity score derived at least in part based on analysis of a social graph maintained by a social networking service;
aggregate individual social proximity scores for the existing customer accounts to derive an aggregated social proximity score representing a measure of how socially connected the candidate is to the set of existing customer accounts; and
present information identifying the candidate along with the aggregated social proximity score of the candidate.

13. The non-transitory computer readable storage medium of claim 13, wherein the instructions, when executed, further cause the computer to:
prior to receiving the data identifying the candidate, receive data identifying a set of entities representing the set of existing customer accounts, with each entity in the set of entities being represented in a social graph of a social networking service.

14. The non-transitory computer readable storage medium of claim 13, wherein the instructions, when executed, further cause the computer to:
present an individual social proximity score representing a measure of how socially connected the candidate is to a particular entity representing a particular customer account.

15. The non-transitory computer readable storage medium of claim 13, wherein the instructions, when executed, further cause the computer to:
derive one or more measures of central tendency for the respective social proximity scores of the existing customer accounts to include a mean, mode and/or median social proximity score; and
presenting one or more of the measures of central tendency with the information identifying the candidate.

16. The non-transitory computer readable storage medium of claim 13, wherein the instructions, when executed, further cause the computer to:
present information identifying each of a plurality of candidates for the open sales representative position; and
present with each candidate an aggregated social proximity score representing a measure of how socially connected a respective candidate is to the set of existing customer accounts.

17. The non-transitory computer readable storage medium of claim 13, wherein the instructions, when executed, further cause the computer to:
determine that an individual social proximity score for a particular customer account in the set of customer accounts is less than a predefined threshold score established for the particular customer account; and
present with the information identifying the candidate additional information indicating that the candidate has a social proximity score for at least one customer account in the set of customer accounts that is less than the predefined threshold.

18. The non-transitory computer readable storage medium of claim 13, wherein the instructions, when executed, further cause the computer to:
determine the number of social proximity scores for customer accounts in the set of customer accounts that exceed a predefined threshold score established for each customer account; and
present with the information identifying the candidate additional information indicating the number of social proximity scores that exceed the predefined threshold score established for each customer account.

19. The non-transitory computer readable storage medium of claim 13, wherein the social proximity score for a customer account is derived as a weighted combination of the number of first-degree and the number of second-degree connections that the candidate has with other members of the social networking service who have member profile information i) indicating current employment with an entity representing the customer account, and ii) satisfying some predefined criteria established specifically for the customer account.

20. The non-transitory computer readable storage medium of claim 13, wherein the member profile information satisfying some predefined criteria includes member profile information indicating that a member having member profile information indicating current employment with the organization representing the customer account has a job title matching any one of a plurality of predefined job titles.

21. The non-transitory computer readable storage medium of claim 13, wherein the member profile information satisfying some predefined criteria includes member profile information indicating that a member having member profile information indicating current employment with the organization representing the customer account has a job function matching any one of a plurality of predefined job functions.

22. The non-transitory computer readable storage medium of claim 13, wherein the member profile information satisfying some predefined criteria includes member profile information indicating that a member having member profile information indicating current employment with the organization representing the customer account has a seniority level that meets or exceeds some predefined seniority level.
